(19) United States
(12) Patent Application Publication
(10) Pub. No.: US 2026/0097912 A1
(43) Pub. Date: Apr. 9, 2026

(54) ACTUATABLE QUICK CHANGEOVER STAND FOR A VEHICLE

(71) Applicant: Buyers Products Company, Mentor, OH (US)

(72) Inventors: Scott Moorman, Chardon, OH (US); Philip Sandler, Mayfield Village, OH (US); Dale Sly, Jefferson, OH (US)

(73) Assignee: Buyers Products Company, Mentor, OH (US)

(21) Appl. No.: 18/907,848

(22) Filed: Oct. 7, 2024

(51) Int. Cl. B65G 67/20; B60P 1/64

(52) U.S. Cl. CPC B65G 67/20; B60P 1/6409

(57) ABSTRACT

Provided in this disclosure is an actuatable quick changeover device stand for placing and removing a load from a bed of a vehicle. The device stand includes a traversable base having a planar surface for supporting the load and configured for rearward displacement off the open gate end of the bed. First and second support assemblies are mounted to the traversable base and configured to extend onto an underlying surface behind the open gate end of the bed to support the load. A pivoting support assembly is mounted to the traversable base and configured for pivoting into contact with the bed to support the load during the rearward displacement. An actuator is connected to the pivoting support assembly for inclining the pivoting support assembly toward the bed at a predetermined tilt angle with respect to the planar surface of the traversable base.

### I. BACKGROUND

### A. Technical Field

The present invention relates generally to the field of load carrying accessories for a vehicle. More specifically, the present invention relates to spreader devices used for distributing a material onto a surface from a vehicle, and systems for moving such spreader devices onto and off of the vehicle.

### B. Description of Related Art

Material spreaders are widely utilized for transporting and dispersing materials, such as salt or sand, across surfaces like sidewalks, parking lots, driveways, and roadways from the rear of a vehicle. Typically, material spreaders include a hopper to store the material, a frame to support the hopper and attach it to the rear of a vehicle, and a mechanism for spreading the material.

Spreaders are often physically connected to the vehicle and might only be removed at the end of a season (e.g., winter) since removal can be a difficult task. This requires dedicating the bed of the vehicle (e.g., a pickup truck) to retaining the spreader for the duration. This is inconvenient for vehicle owners who cannot dedicate a vehicle and require multiple uses with the same vehicle.

Spreader mounting structures are complicated, requiring multiple personnel to mount and remove, and do not readily enable the spreader to be moved onto and off of the vehicle bed. It is known to have a stand onto which a spreader can be removably retained onto and off of the vehicle bed. One known stand is mounted on a dump truck and requires the dump body to be tilted upward to remove the stand from the vehicle. Another type shows a stand for use with a pickup but that is unstable and therefore unsafe during removal and mounting.

Other types of vehicles could also removably retain a load onto and off of a vehicle bed. For example, a utility vehicle such as a golf cart could be used to transport a bin loaded with fertilizer or dirt. Similarly, a boat could be used to move a drum dispenser holding fish food or bait. A pickup truck might be used to transport welding or other heavy equipment. If a prior art stand were adapted for such uses, the same problems would exist as noted hereinabove.

### II. SUMMARY

Provided in this disclosure is an actuatable quick changeover device stand for placing and removing a load from a bed of a vehicle. The device stand includes a traversable base having a planar surface for supporting the load, including an anterior toward a cabin end of the vehicle at a front of the bed, and a posterior toward an open gate end of the vehicle at a rear of the bed. The traversable base is configured for rearward displacement off the open gate end of the bed. A first support assembly is mounted proximal to the posterior of the traversable base and configured to extend onto an underlying surface behind the open gate end of the bed to support the load. A second support assembly is mounted proximal to the anterior of the traversable base and configured to extend onto the underlying surface upon the rearward displacement of the traversable base off the open gate end of the bed. A pivoting support assembly is mounted proximal to the anterior of the traversable base and configured for pivoting into contact with the bed to support the load during the rearward displacement. An actuator is connected to the pivoting support assembly for inclining the pivoting support assembly toward the bed at a predetermined tilt angle with respect to the planar surface of the traversable base.

In another aspect, the first support assembly is an extendable support assembly including first and second extendable legs each configured to slidably extend onto the underlying surface behind the open gate end of the bed to support the load. The extendable support assembly also includes first and second sleeves for respectively surrounding and supporting the extendable legs. The second support assembly is a foldable support assembly including first and second foldable legs mounted to swivel between a folded position flush with the traversable base and an operative position onto the underlying surface for supporting the load upon the rearward displacement of the traversable base off the open gate end of the bed. The foldable support assembly also includes first and second hinges, mounted to opposite sides of the traversable base, for respectively hingeably mounting the first and second foldable legs.

In yet another aspect, the pivoting support assembly is mounted coplanar with the planar surface of the traversable base and also includes a hinge assembly for pivotally connecting the pivoting support assembly to the traversable base. The pivoting support assembly is spaced apart from the transverse base and the hinge assembly extends perpendicularly from the plane of the transverse base, to enable the pivoting support assembly to incline inwardly at the predetermined tilt angle. The pivoting support assembly includes one or more rollers to enable the traversable base to roll off the open gate end of the bed upon the rearward displacement. The actuator is a ball screw mounted alongside the traversable base for retracting the pivoting support assembly toward the traversable base to incline the pivoting support assembly toward the bed at the predetermined tilt angle. The actuator also includes a hand crank, mounted proximal to the posterior of the traversable base, configured for manually rotating the ball screw to retract the pivoting support assembly.

In still another aspect, the load is a spreader for distributing a material onto a roadway such as salt or sand in the wintertime. However, it is to be appreciated that the load can be any load that can be moved onto or off of a vehicle.

In a further aspect, an actuatable quick changeover device stand for placing and removing a load from a bed of a vehicle includes a traversable base having a planar surface for supporting the load, including an anterior toward a cabin end of the vehicle at a front of the bed, and a posterior toward an open gate end of the vehicle at a rear of the bed. The traversable base is configured for rearward displacement off the open gate end of the bed. An extendable support assembly is mounted proximal to the posterior of the traversable base and includes first and second extendable legs each configured to slidably extend onto an underlying surface behind the open gate end of the bed to support the load. A foldable support assembly is mounted proximal to the anterior of the traversable base and including first and second foldable legs mounted to swivel between a folded position flush with the traversable base and an operative position onto the underlying surface for supporting the load upon the rearward displacement of the traversable base off the open gate end of the bed. A pivoting support assembly is mounted proximal to the anterior of the traversable base and coplanar with the planar surface and configured for pivoting into contact with the bed to support the load during the rearward displacement. A hinge assembly pivotally connects the pivoting support assembly to the traversable base. One or more rollers are provided for supporting the pivoting support assembly to enable the traversable base to roll off the open gate end of the bed upon the rearward displacement. An actuator is connected to the pivoting support assembly for inclining the pivoting support assembly toward the bed at a predetermined tilt angle with respect to the planar surface of the traversable base.

In another further aspect, the pivoting support assembly is spaced apart from the transverse base and the hinge assembly extends perpendicularly from the plane of the transverse base, to retract the pivoting support assembly to incline inwardly at the predetermined tilt angle. The actuator includes a ball screw mounted alongside the traversable base for retracting the pivoting support assembly toward the traversable base to incline the pivoting support assembly toward the bed at the predetermined tilt angle. A hand crank is mounted proximal to the posterior of the traversable base and configured for manually rotating the ball screw to retract the pivoting support assembly.

In yet another further aspect, a method is provided of removing a load from a bed of a vehicle. An actuatable quick changeover stand device is provided including a traversable base having a planar surface for supporting the load, a pivoting support assembly mounted coplanar with the planar surface of the traversable base, an extendable support assembly, and a foldable support assembly. The extendable support assembly is extended onto an underlying surface behind an open gate end of the bed to partially support the load. The pivoting support assembly is pivoted into contact with the bed at a predetermined tilt angle with respect to the planar surface of the traversable base to partially support the load. The actuatable quick changeover stand device is rearwardly displaced a portion of a length of the traversable base to expose the foldable support assembly while the load is partially supported by the extendable support assembly. The foldable support assembly is swiveled from a folded position flush with the traversable base to an operative position onto the underlying surface for fully supporting the load. The actuatable quick changeover stand device is rearwardly displaced off the open gate end of the bed.

In still another further aspect, the step of rearwardly displacing the actuatable quick changeover stand device includes advancing the vehicle while the load is at least partially supported. The method of removing a load includes removing a spreader from the bed of the vehicle.

According to an aspect, the present invention discloses a spreader mounting structure that is uncomplicated.

According to another aspect, the present invention discloses a spreader support stand that can be mounted to and removed from a vehicle without requiring multiple personnel.

According to yet another aspect, the present invention discloses a spreader support stand that can be mounted to a vehicle without requiring a dump body to be tilted upward to remove the stand.

According to still another aspect, the present invention discloses a spreader support stand for use with a pickup that is stable and safe during removal and mounting.

According to another aspect, the present invention discloses a support stand that could be adapted for removably retaining other types of loads onto and off of a vehicle such as pickup truck used to transport welding or other heavy equipment.

According to another further aspect, the present invention discloses a support stand that could be adapted for removably retaining a load onto and off of a bed of other vehicles including a golf cart or a boat.

Other benefits and advantages of this invention will become apparent to those skilled in the art to which it pertains upon reading and understanding of the following detailed specification.

### III. BRIEF DESCRIPTION OF THE DRAWINGS

The disclosed actuatable quick changeover stand device may take physical form in certain parts and arrangement of parts, embodiments of which will be described in detail in this specification and illustrated in the accompanying drawings which form a part hereof. The description herein refers to the provided drawings in which similar reference characters refer to similar parts throughout the different views.

FIGS. 1A, 1B, 1C, 1D, 1E, 1F, and 1G respectively illustrate perspective, top, bottom, left side, front, right side, and rear views of an exemplary embodiment of an actuatable quick changeover stand device in accordance with the present invention.

FIGS. 2A, 2B, 2C, 2D, 2E, 2F, and 2G respectively illustrate perspective, top, bottom, left side, front, right side, and rear views of an exemplary embodiment of an actuatable quick changeover stand device supporting a spreader in accordance with the present invention.

FIGS. 3A, 3B, and 3C respectively illustrate perspective and side views of an exemplary embodiment of an actuatable quick changeover stand device in the operative unfolded position (FIG. 3A) and the folded position (FIGS. 3B and 3C) in accordance with the present invention.

FIGS. 4A, 4B, and 4C are side views respectively illustrating an exemplary embodiment of an actuatable quick changeover stand device as used with different types of spreaders in accordance with the present invention.

FIGS. 5A, 5B, and 5C are side views respectively illustrating an exemplary embodiment of an actuatable quick changeover stand device mounted on a vehicle with different types of spreaders in accordance with the present invention.

FIGS. 6A, 6B, 6C, and 6D are perspective views respectively illustrating four stages of removable of actuatable quick changeover stand device with a spreader from a vehicle in accordance with the present invention.

### IV. DETAILED DESCRIPTION

Referring now to the drawings wherein the showings are for purposes of illustrating embodiments of the article only and not for purposes of limiting the same, and wherein like reference numerals are understood to refer to like components:

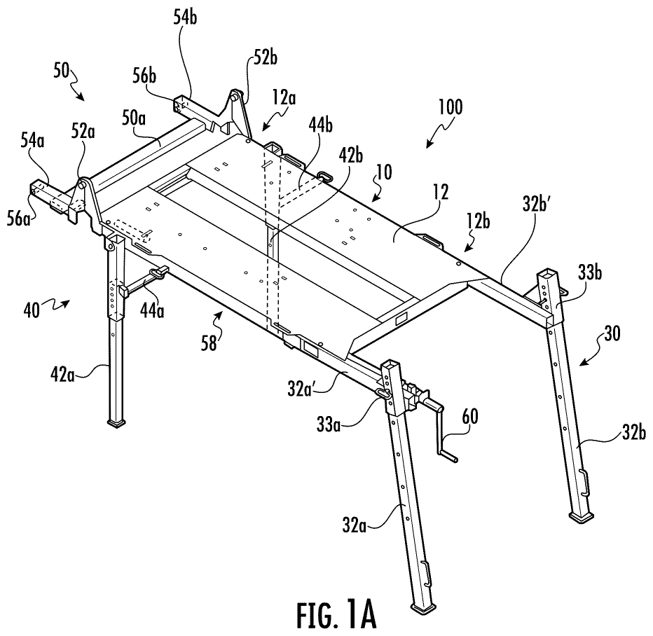

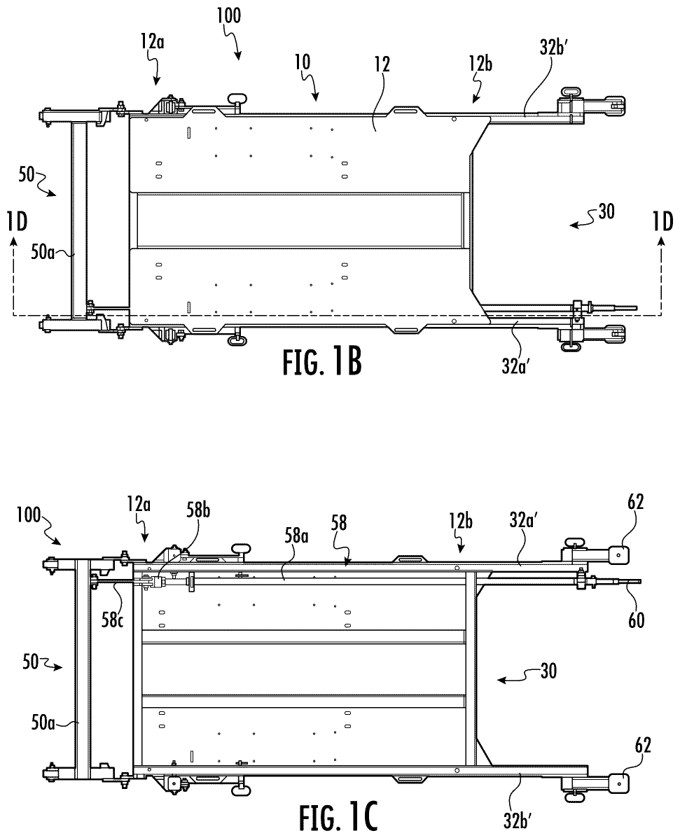

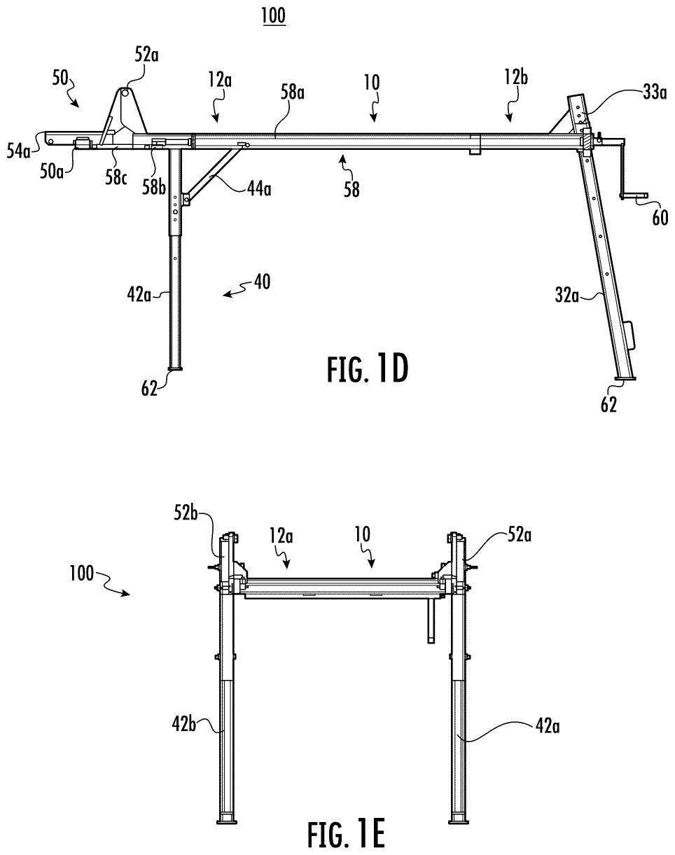

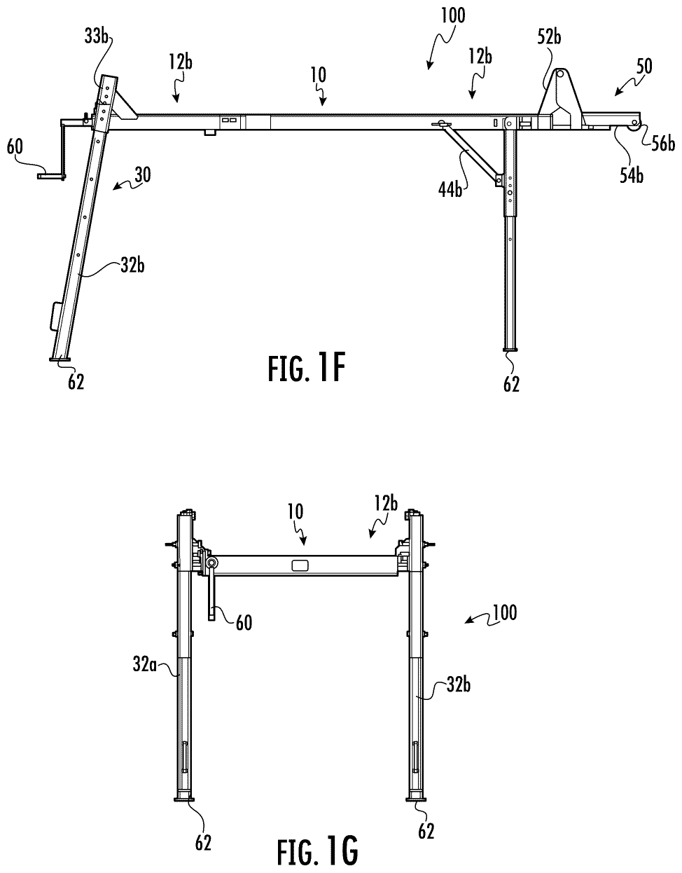

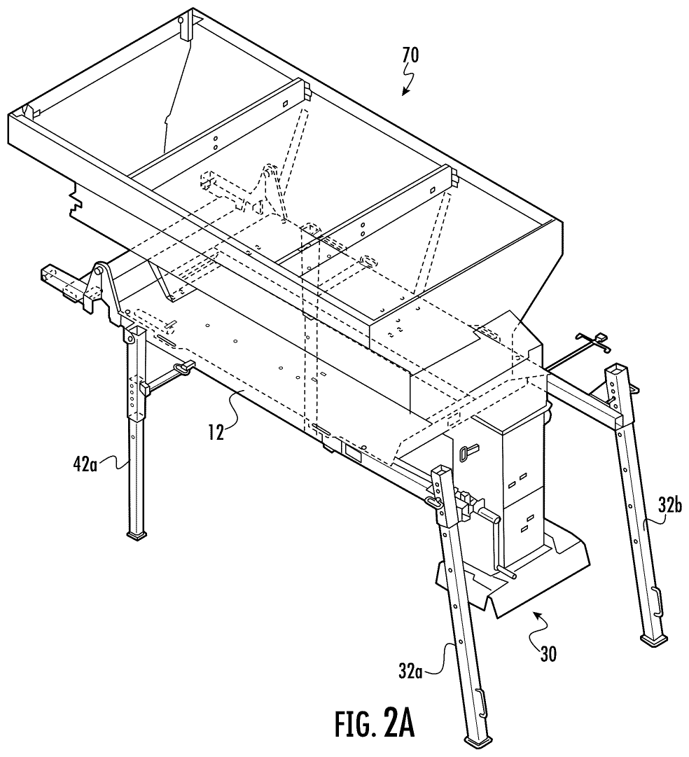

Referring initially to the drawings, FIG. 1 illustrates a perspective view of an exemplary embodiment of an actuatable quick changeover stand 100 for placing and removing a load from a bed of a vehicle in accordance with the present invention. The stand 100 generally includes a traversable base 10, a first support assembly 30, a second support assembly 40, an actuator 58, and a pivoting support assembly 50.

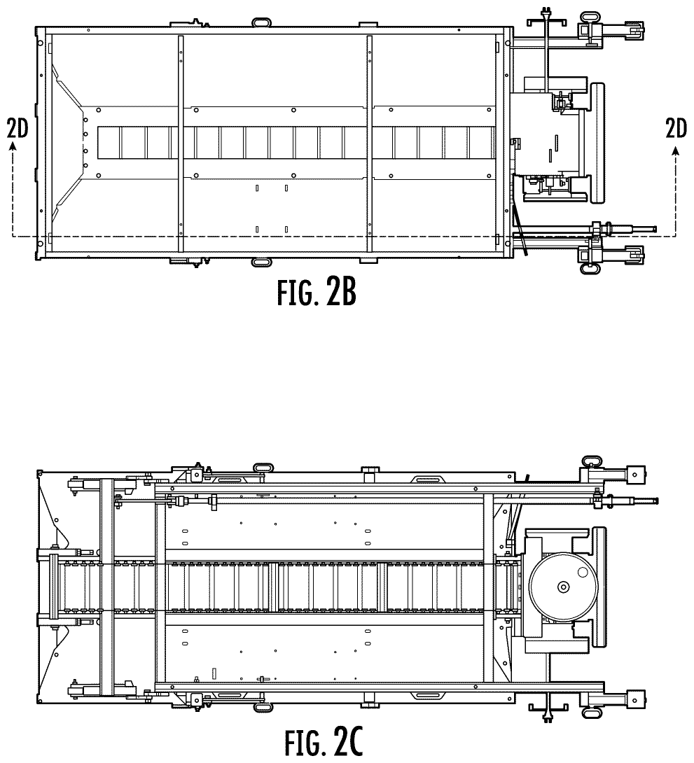

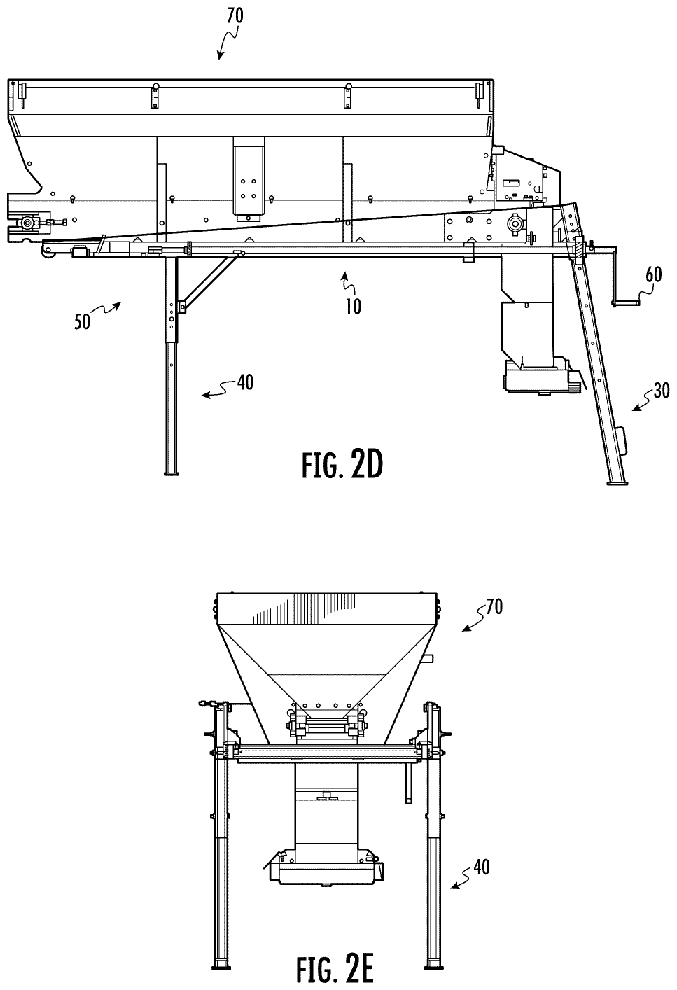

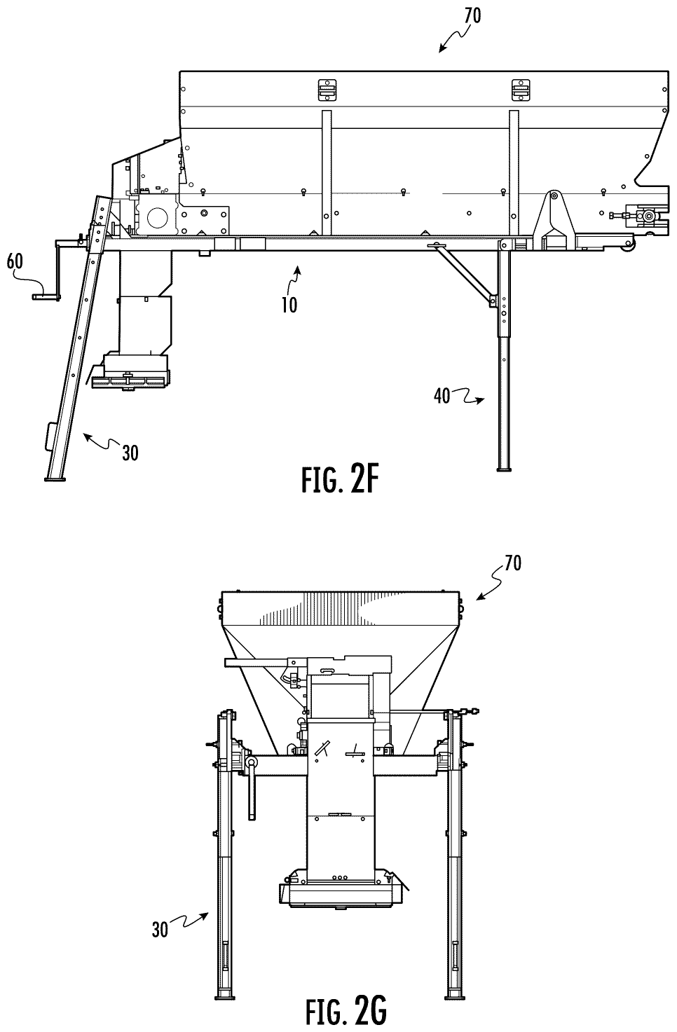

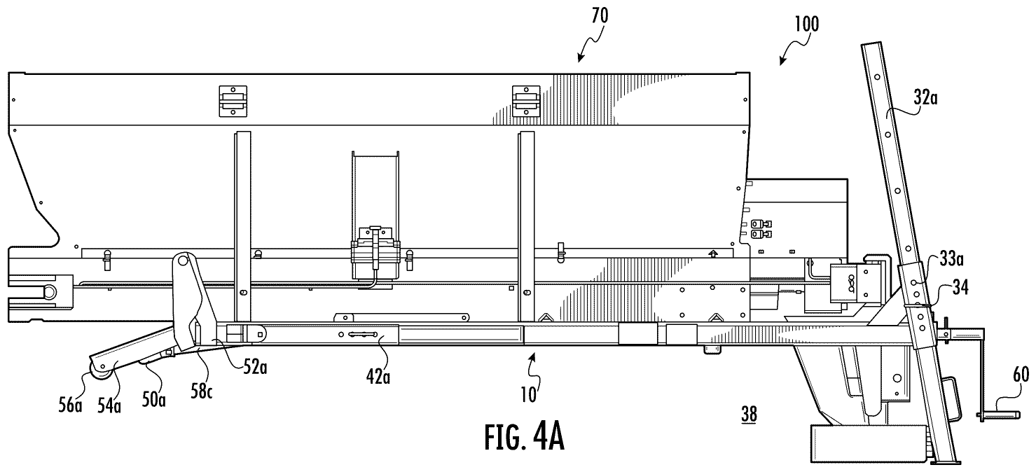

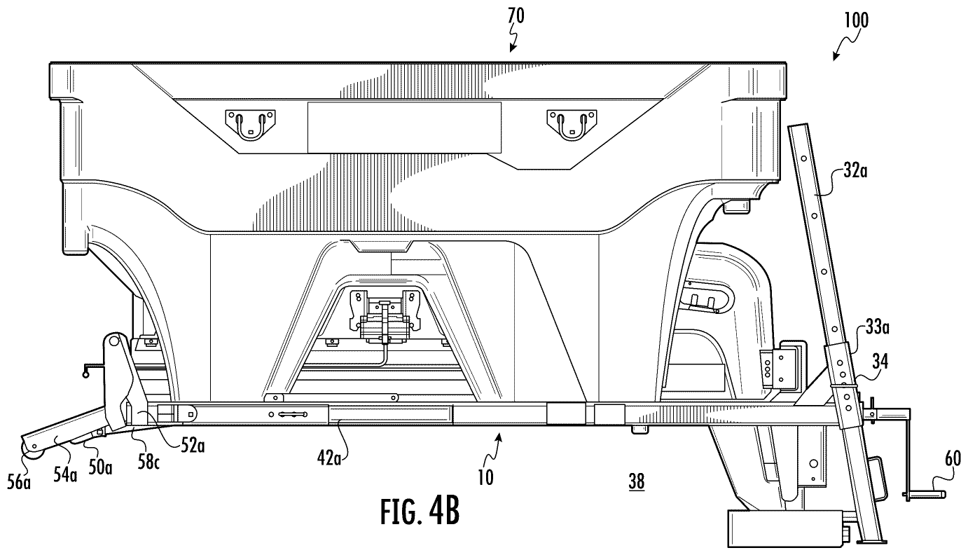

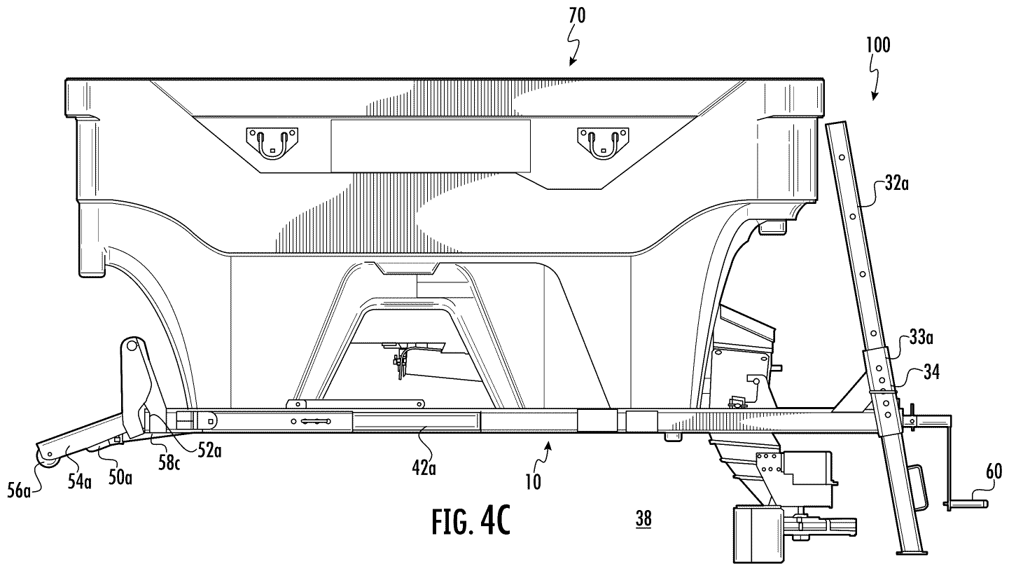

In an exemplary embodiment such as FIGS. 4A, 4B, 4C, 5A, 5B, 5C, 6A, 6B, 6C, the load is a spreader 70 having a hopper for distributing a material onto a roadway from behind the vehicle 80. However, it is to be appreciated that the load can be any other type of load (e.g., material, equipment, etc.) without departing from the invention. FIGS. 1A, 1B, 1C, 1D, 1E, and 1F depict the stand 100 alone, to more clearly show the components. FIGS. 2A, 2B, 2C, 2D, 2E, and 2F depict the stand 100 supporting the spreader 70, to more clearly show the stand 100 in an operative state.

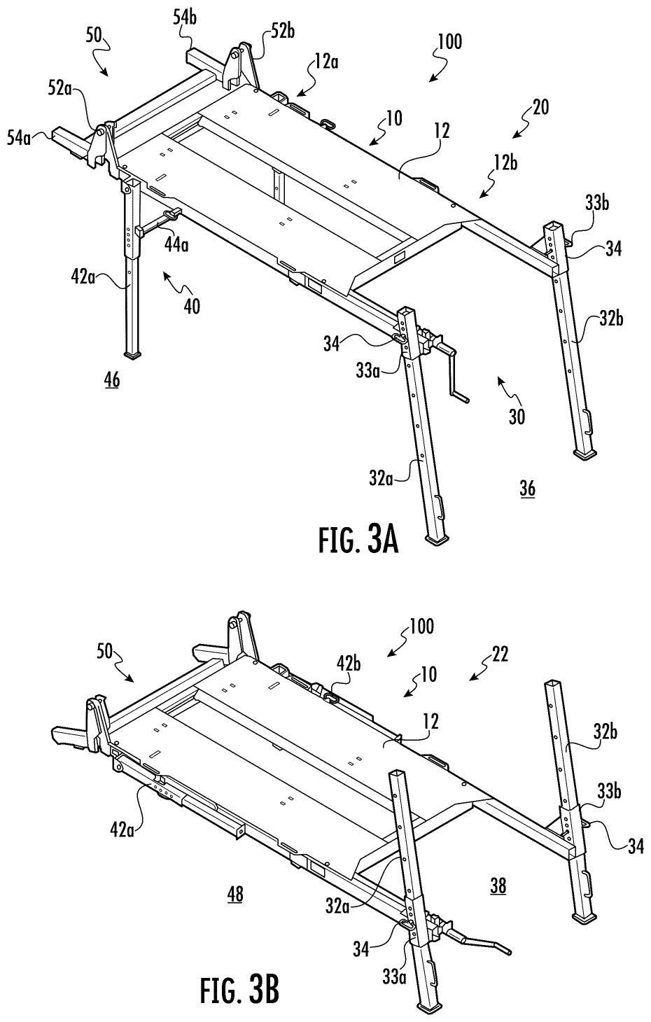

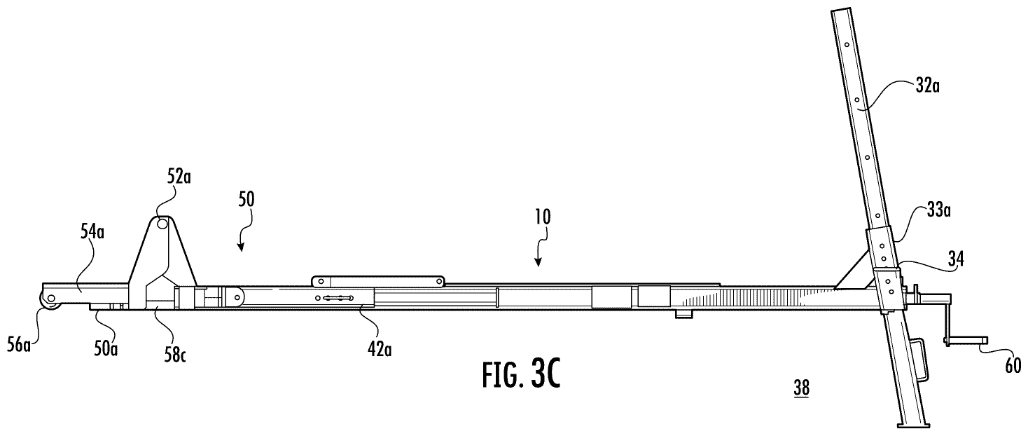

With reference to FIGS. 1A, 1B, 1C, 1D, 1E, and 1F, the traversable base 10 includes a planar surface 12 for supporting a load (e.g., such as a spreader 70 as shown in FIG. 2A and other figures). The planar surface 12 of the traversable base 10 includes an anterior 12a and a posterior 12b, as will be described in detail hereinbelow. The stand 100 is capable of being actuated vertically into two different positions. As seen in FIG. 3A, the stand 100 is in a loaded position 20 where the planar surface 12 can support a load on an underlying surface such as the ground, away from the vehicle. As seen in FIG. 3B, the stand 100 is in an unload position 22 where the planar surface 12 can support a load on the bed of the vehicle. The traversable base 10 is preferably made from a corrosion resistant material, which may be stainless, galvanized, or powder coated carbon steel. The base 10 is preferably rectangular but can be any shape in different embodiments.

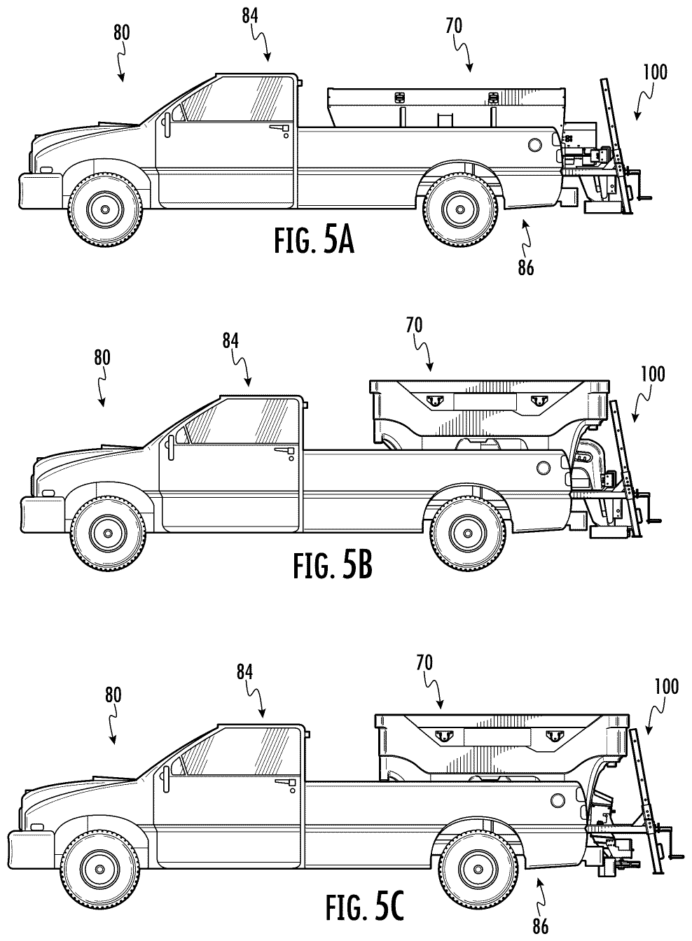

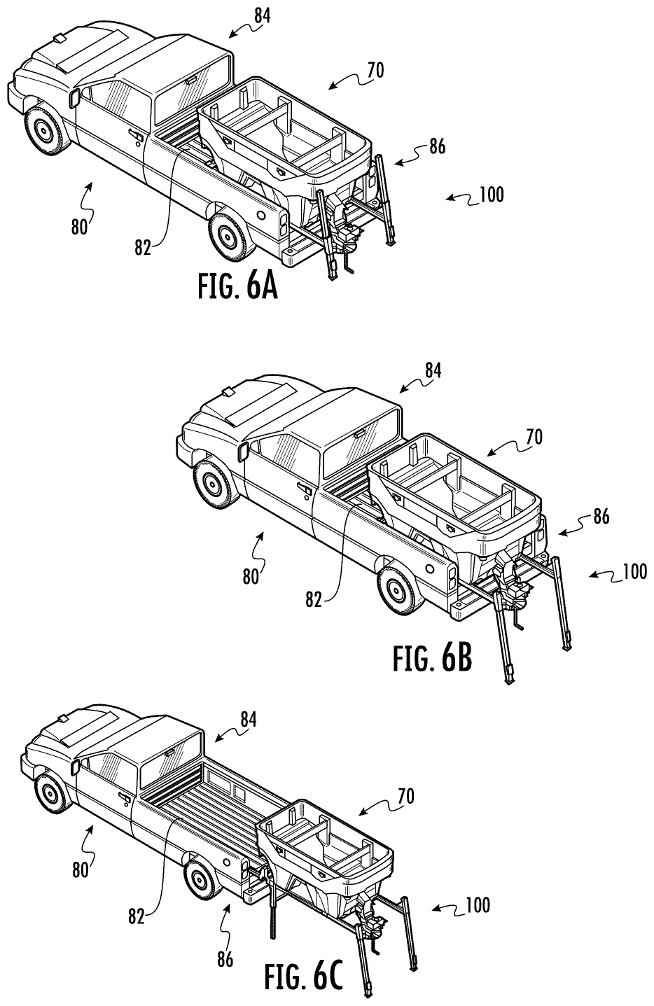

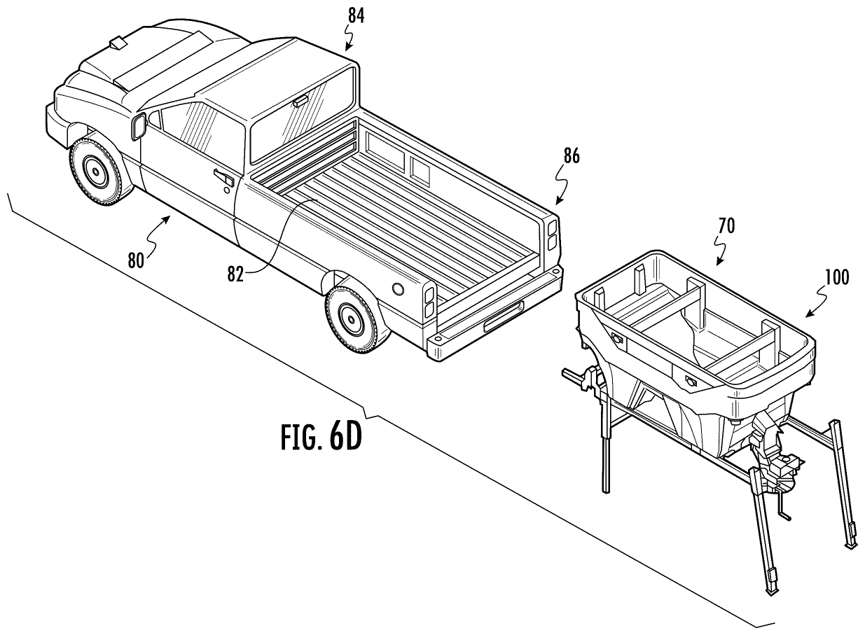

With specific reference to FIGS. 5A, 5B, 5C, 6A, 6B, 6C, and 6D, the anterior 12a of the traversable base 10 is received within a vehicle 80 toward a cabin end 84 at the front of the vehicle bed 82. The posterior 12b is received toward an open gate end 86 of the vehicle 80 at a rear of the vehicle bed 82. When the stand 100 is mounted atop the vehicle bed 82, the traversable base 10 is configured for rearward displacement off the open gate end 86 of the vehicle bed 82.

As depicted in FIGS. 1A, 1D, 1F, 2A, 2D, and 2F, the first support assembly 30 is mounted on the traversable base 10 at a position proximal to the posterior 12b of the traversable base 10. The first support assembly 30 is configured to extend backwards from the open gate end 86 of the vehicle 80 and extend downwardly onto the underlying surface (e.g., the ground) behind the open gate end 86 of the bed 82 to support the load 70.

With continued reference to FIGS. 1A, 1D, 1F, 2A, 2D, and 2F, the first support assembly 30 is an extendable support assembly 30 that includes first and second extendable support legs 32a, 32b respectively which are configured to slidably extend onto the underlying surface behind the open gate end 86 of the bed 82 to support the load 70. The extendable support legs 32a, 32b are respectively to the right and left sides of the traversable base 10 proximal to the posterior end 12b of the traversable base 10 using extending mounts 32a′, 32b′ which extend backwards from the traversable base 10 and out behind the open gate end 86 of the vehicle 80.

With further reference to FIGS. 1A, 1D, 1F, 2A, 2D, and 2F, the support legs 32a, 32b of the first support assembly 30 are preferably configured as two distinct, independently operable components, which provides stability but also allows clearance for a spreader chute that may flip UP or SIDEWAYS for service or storage. The present stand 100 thus allows for the quick installation and removal of a load from a vehicle, as described hereinabove, but it also allows the installation/removal a truck accessory without impeding its function or requiring extensive reconfiguration (e.g., removing the chute, etc.). The rear support legs 32a, 32b are mounted on the extending mounts 32a′, 32b′ (i.e., side rails) at a distance rearward from the traversable base 10 and are not connected by a crosspiece to allow for accessory components that may protrude below the planar surface of the traversable base 10 (i.e. chutes, etc.). In this manner, the rear of the vehicle is left completely open, making it easy to access/remove/operate components (i.e. chutes). The separate rear legs 32a, 32b provide additional stability with four points of contact, but also provide for improved function for the aforementioned reasons.

With ongoing reference to FIGS. 1A, 1D, 1F, 2A, 2D, and 2F, the support legs 32a, 32b include support feet 62. The support feet 62 can include a pad around the feet of the legs 32a, 32b. The support feet 62 can include a rubber pad that fits over the ends of the legs 32a, 32b to secure the legs 32a, 32b to the ground by raising the coefficient of friction between the legs 32a, 32b and the underlying surface (which include a polished factory floor, for example). Alternatively, the support feet 62 can include an abrasive pad or an abrasive pattern etched into the bottom surface of the legs 32a, 32b to enable the feet 62 to better grip the surface. In this manner, the support feet 62 can minimize the likelihood of the legs 32a, 32b sliding across the underlying surface and thereby increase the likelihood that the legs 32a, 32b remain affixed to a certain spot on the floor.

Again referencing 1A, 1D, 1F, 2A, 2D, and 2F, the first and second extendable support legs 32a, 32b of the extendable support assembly 30 are slidably supported with respective first and second support sleeves 33a, 33b for respectively surrounding and supporting the extendable support legs 32. The support sleeves 33a, 33b have a generally square cross-sectional profile in order to receive a mating shape of the support legs 32a, 32b. As seen in FIG. 3A the extendable support legs 32a, 32b are in an extended position 36 and in FIG. 3B the extendable support legs 32a, 32b are in an un-extended position 38. In the un-extended position 38, the extendable support legs 32a, 32b can be slid up and down within the sleeves 33a, 33b or removed. Each sleeve 33a, 33b and leg 32a, 32b can include a locking fastener 34 which can be a lynch pin, quick release pin, spring pin or any other form of fastener used to align and prevent movement of components, is used to secure the extendable support legs 32a, 32b in either the extended position 36 or the un-extended position 38.

As shown in FIGS. 1A, 1D, 1E, 2A, 2D, and 2E, the second support assembly 40 is mounted on the traversable base 10 at a position proximal to the anterior 12a of the traversable base 10, near the cabin end 84 of the vehicle 80. The second support assembly 40 is a foldable support assembly 40 that includes first and second foldable support legs 42a, 42b, hinges 44a, 44b, and support feet 62. The foldable support legs 42a, 42b are configured to extend onto the underlying surface upon the rearward displacement of the traversable base 10 off the open gate end 86 of the bed 82 of the vehicle 80. The foldable support assembly 40 is located proximal to the anterior end 12a of the traversable base 10. The first and second hinges 44a, 44b are mounted to opposite sides of the traversable base 10, for respectively hingeably mounting the first and second foldable legs 42.

With specific reference to FIG. 3A. and 3B., the foldable support legs 42a, 42b are configured to swivel between an unfolded operative position 46 with the hinges 44a, 44b fully extended, as seen in FIG. 3A, and a folded position 48 where the foldable support legs 42a, 42b are flush with the traversable base 10, as seen in FIG. 3B. In the unfolded operative position 46, the support feet 62 of the second support assembly 40 contact the underlying surface (e.g., the ground) supporting a load 70 upon the rearward displacement of the traversable base 10 off the open gate 86 end of the bed 82.

As particularly depicted in FIGS. 1A, 2A, 3C the pivoting support assembly 50 is mounted proximal to the anterior 12a of the traversable base 10 and configured for pivoting into contact with the bed 82 to support the load 70 during the rearward displacement. The pivoting support assembly 50 includes structures mounted on the left and right sides of the stand 100, including respective hinges 52a, 52b and guide legs 54a, 54b which are pivoted by the hinges 52a, 52b, and rollers 56a, 56b mounted at extreme ends of the guide legs 54a, 54b. In this manner, the pivoting support assembly 50 is configured for pivoting into contact with the bed 82 of the vehicle 80 to support the load 70 during the rearward displacement.

With continued reference to FIGS. 1A, 2A, and 3C the pivoting support assembly 50 is mounted coplanar with the planar surface 12 of the traversable base 10. The hinges 52a, 52b are components of a hinge assembly for pivotally connecting the pivoting support assembly 50 to the traversable base 10. The pivoting support assembly 50 is configured such that it is spaced apart from the traversable base 10.

As shown in FIGS. 3B, 4A, 4B, and 4C, the hinges 52a, 52b of the hinge assembly 52 extend perpendicularly upwards from the planar surface 12 of the traversable base 10 and pivot inwardly so that the guide legs 54a, 54b pivot downwardly into contact with the vehicle bed 82 at a predetermined tilt angle (e.g., about 20 degrees). In so doing, the pivoting support assembly 50 and the rollers 56a, 56b support the weight of the load 70 atop the bed 82. In this manner, the rollers 56a, 56b enable the traversable base 10 with the load 70 to be lifted off the bed 82 and roll off the open gate end 86 of the bed 82 upon the rearward displacement.

With specific reference to FIGS. 1A, 1C, and 1D, an actuator 58 is connected to the pivoting support assembly 50 for inclining the pivoting support assembly 50 toward the bed 82 at the predetermined tilt angle with respect to the planar surface 12 of the traversable base 10. In an exemplary embodiment, the actuator 58 is a manually operated component that extends along the length of the traversable base 10 from a position proximal to the posterior 12b to a position proximal to the anterior 12a. In that respect, as particularly revealed in FIG. 1D (a sectional view along a line A-A of FIG. 1B), the actuator 58 preferably includes a ball screw 58a mounted alongside the traversable base 10. The ball screw 58a is connected to a threaded member 58b. When the ball screw 58a is rotated, the threaded member 58b retracts in a direction from the anterior 12a toward the posterior 12b. The threaded member 58b is in turn connected to a linkage 68c also connected to a bar 50c of the pivoting support assembly 50 which spans and connects the two guide legs 54a, 54b. The retraction of the threaded member 58b in turn retracts the linkage 58c, which tilts downwardly (FIGS. 5A, 5B, 5C) and in turn retracts both of the guide legs 54a, 54b of the pivoting support assembly 50 in the direction toward the traversable base 10 (i.e., below the plane of the traversable base 10) to incline the pivoting support assembly 50 downward toward contact with the bed 82 at the predetermined tilt angle. Alternatively, the pivoting support assembly 50 can be configured to incline to move above the plane of the traversable base 10 to allow for adjustment to trucks where the bed may be different than the previous truck used, or if the spreader has “sunk” after removal, since the truck tends to spring up after the load is removed With further specific reference to FIGS. 1A, 1C, and 1D, the actuator 58 can be engaged by a hand crank 60, mounted proximal to the posterior 12b of the traversable base 10, configured for manually rotating the ball screw 58a (and in turn engage the threaded member 58b and linkage 58c) to retract the guide legs 54a, 54b and thus the entire pivoting support assembly 50. However, an alternative embodiment can be contemplated in which an actuator motor can be substituted for the hand crank 60, all without departing from the invention.

Steps of a method are depicted in FIGS. 3A, 3B, 4A, 4B, 4C, 6A, 6B, 6C, and 6D. First, the stand 100 is provided including a traversable base 10 having a planar surface 12 for supporting a load 70, as described hereinabove, further including a pivoting support assembly 50 mounted coplanar with the planar surface 12 of the traversable base 10, an extendable support assembly 30, and a foldable support assembly 40 (FIG. 6A). Next, the extendable support assembly 30 is extended onto an underlying surface behind a bed 82 of a vehicle 80 to partially support the load 70 (FIGS. 3A, 6B). Following the previous step, the pivoting support assembly 50 is then pivoted into a predetermined angle so that the pivoting support assembly 50 contacts the bed 82 of the vehicle 80 to partially support a load 70 (FIGS. 3A, 4A, 4B, 4C).

As specifically shown in FIG. 6C, the actuatable quick changeover stand 100 is rearwardly displaced a portion of a length of the traversable base 10 to expose the foldable support assembly 40 while the load 70 is partially supported by both the pivoting support assembly 50 and the extendable support assembly 30. Preferably, the rearward displacement of the stand 100 is performed by advancing the vehicle 80 while the load 70 is at least partially supported on the bed 82 by the pivoting support assembly 50 and on the ground by the extendable support assembly 30. The foldable support legs 42 then can be swiveled from a folded position 48 flush with the planar surface 12 of the traversable base 10 to an operative unfolded position 46 onto the underlying surface for fully supporting the load 70.

Finally, as shown in FIG. 6D, the actuatable quick changeover stand 100 is rearwardly displaced off the bed 82 of the vehicle 80 through the open gate end 82b and thereby entirely supported by the stand 100. It is to be appreciated that the aforementioned method of removing a load is intended for removing a spreader 70 from the bed 82 of the vehicle 80. However, the present stand 100 and method of operating can be readily adapted for use with other types of loads for any type of vehicle, without departing from the invention.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed:

1. An actuatable quick changeover device stand for placing and removing a load from a bed of a vehicle, the device stand comprising:
a traversable base having a planar surface for supporting the load, including an anterior toward a cabin end of the vehicle at a front of the bed, and a posterior toward an open gate end of the vehicle at a rear of the bed, wherein the traversable base is configured for rearward displacement off the open gate end of the bed;
a first support assembly mounted proximal to the posterior of the traversable base and configured to extend onto an underlying surface behind the open gate end of the bed to support the load;
a second support assembly mounted proximal to the anterior of the traversable base and configured to extend onto the underlying surface upon the rearward displacement of the traversable base off the open gate end of the bed;
a pivoting support assembly mounted proximal to the anterior of the traversable base and configured for pivoting into contact with the bed to support the load during the rearward displacement; and
an actuator connected to the pivoting support assembly for inclining the pivoting support assembly toward the bed at a predetermined tilt angle with respect to the planar surface of the traversable base.

2. The actuatable quick changeover device stand of claim 1, wherein the first support assembly is an extendable support assembly including first and second extendable legs each configured to slidably extend onto the underlying surface behind the open gate end of the bed to support the load.

3. The actuatable quick changeover device stand of claim 2, wherein the extendable support assembly further comprises first and second sleeves for respectively surrounding and supporting the extendable legs.

4. The actuatable quick changeover device stand of claim 1, wherein the second support assembly is a foldable support assembly including first and second foldable legs mounted to swivel between a folded position flush with the traversable base and an operative position onto the underlying surface for supporting the load upon the rearward displacement of the traversable base off the open gate end of the bed.

5. The actuatable quick changeover device stand of claim 4, wherein the foldable support assembly further comprises first and second hinges, mounted to opposite sides of the traversable base, for respectively hingeably mounting the first and second foldable legs.

6. The actuatable quick changeover device stand of claim 1, wherein the pivoting support assembly is mounted coplanar with the planar surface of the traversable base and further comprising a hinge assembly for pivotally connecting the pivoting support assembly to the traversable base.

7. The actuatable quick changeover device stand of claim 6, wherein the pivoting support assembly is spaced apart from the transverse base and the hinge assembly extends perpendicularly from the plane of the transverse base, to enable the pivoting support assembly to incline inwardly at the predetermined tilt angle.

8. The actuatable quick changeover device stand of claim 6, wherein the pivoting support assembly further comprises at least one roller to enable the traversable base to roll off the open gate end of the bed upon the rearward displacement.

9. The actuatable quick changeover device stand of claim 6, wherein the actuator comprises a ball screw mounted alongside the traversable base for retracting the pivoting support assembly toward the traversable base to incline the pivoting support assembly toward the bed at the predetermined tilt angle.

10. The actuatable quick changeover device stand of claim 9, wherein the actuator further comprises a hand crank, mounted proximal to the posterior of the traversable base, configured for manually rotating the ball screw to retract the pivoting support assembly.

11. The actuatable quick changeover device stand of claim 1, wherein the load is a spreader for distributing a material onto a roadway.

12. The actuatable quick changeover device stand of claim 1, wherein the extendable and foldable support assemblies comprise legs having support feet for contacting the underlying surface, wherein the support feet each further comprise a pad formed of rubber or an abrasive material for raising the coefficient of friction between the legs and the underlying surface.

13. An actuatable quick changeover device stand for placing and removing a load from a bed of a vehicle, the device stand comprising:
a traversable base having a planar surface for supporting the load, including an anterior toward a cabin end of the vehicle at a front of the bed, and a posterior toward an open gate end of the vehicle at a rear of the bed, wherein the traversable base is configured for rearward displacement off the open gate end of the bed;
an extendable support assembly mounted proximal to the posterior of the traversable base and including first and second extendable legs each configured to slidably extend onto an underlying surface behind the open gate end of the bed to support the load;
a foldable support assembly mounted proximal to the anterior of the traversable base and including first and second foldable legs mounted to swivel between a folded position flush with the traversable base and an operative position onto the underlying surface for supporting the load upon the rearward displacement of the traversable base off the open gate end of the bed;
a pivoting support assembly mounted proximal to the anterior of the traversable base and coplanar with the planar surface and configured for pivoting into contact with the bed to support the load during the rearward displacement;
a hinge assembly for pivotally connecting the pivoting support assembly to the traversable base;
at least one roller for supporting the pivoting support assembly to enable the traversable base to roll off the open gate end of the bed upon the rearward displacement; and
an actuator connected to the pivoting support assembly for inclining the pivoting support assembly toward the bed at a predetermined tilt angle with respect to the planar surface of the traversable base.

14. The actuatable quick changeover device stand of claim 13, wherein the pivoting support assembly is spaced apart from the transverse base and the hinge assembly extends perpendicularly from the plane of the transverse base, to retract the pivoting support assembly to incline inwardly at the predetermined tilt angle.

15. The actuatable quick changeover device stand of claim 13, wherein the actuator comprises a ball screw mounted alongside the traversable base for retracting the pivoting support assembly toward the traversable base to incline the pivoting support assembly toward the bed at the predetermined tilt angle.

16. The actuatable quick changeover device stand of claim 15, further comprising a hand crank, mounted proximal to the posterior of the traversable base, configured for manually rotating the ball screw to retract the pivoting support assembly.

17. A method of removing a load from a bed of a vehicle, comprising steps of:
providing an actuatable quick changeover stand device comprising a traversable base having a planar surface for supporting the load, a pivoting support assembly mounted coplanar with the planar surface of the traversable base, an extendable support assembly, and a foldable support assembly;
extending the extendable support assembly onto an underlying surface behind an open gate end of the bed to partially support the load;
pivoting the pivoting support assembly into contact with the bed at a predetermined tilt angle with respect to the planar surface of the traversable base to partially support the load;
rearwardly displacing the actuatable quick changeover stand device a portion of a length of the traversable base to expose the foldable support assembly while the load is partially supported by the extendable support assembly;
swiveling the foldable support assembly from a folded position flush with the traversable base to an operative position onto the underlying surface for fully supporting the load; and
rearwardly displacing the actuatable quick changeover stand device off the open gate end of the bed.

18. The method of claim 17, wherein the rearwardly displacing the actuatable quick changeover stand device comprises advancing the vehicle while the load is at least partially supported.

19. The method of claim 17, wherein the method of removing a load comprises removing a spreader from the bed of the vehicle.
